(19) United States
(12) Patent Application Publication
(10) Pub. No.: US 2025/0135952 A1
(43) Pub. Date: May 1, 2025

(54) BATTERY CONDITIONING METHOD FOR A MOBILITY APPARATUS AND A MOBILITY APPARATUS IMPLEMENTING THE SAME

(71) Applicants: HYUNDAI MOTOR COMPANY, SEOUL (KR); KIA CORPORATION, SEOUL (KR)

(72) Inventor: Won Jae Lee, Hwaseong-si (KR)

(73) Assignees: HYUNDAI MOTOR COMPANY, SEOUL (KR); KIA CORPORATION, SEOUL (KR)

(21) Appl. No.: 18/921,666

(22) Filed: Oct. 21, 2024

(30) Foreign Application Priority Data
Oct. 30, 2023 (KR) 10-2023-0146894

(51) Int. Cl. B60L 58/21; B60L 50/60; B60L 58/24; H01M 10/42; H01M 10/625; H01M 10/63

(52) U.S. Cl. CPC B60L 58/21; B60L 50/60; B60L 58/24; H01M 10/425; H01M 10/625; H01M 10/63; B60L 2240/545; H01M 2220/20

(57) ABSTRACT

A mobility apparatus includes a plurality of first wheels, at least one first driving motor configured to provide a driving force to the plurality of first wheels, a first high voltage battery configured to supply power to the at least one first driving motor, and a first controller configured to control the at least one first driving motor and the first high voltage battery, and, when a second high voltage battery is removably and electrically connected to a first mobility apparatus, the first controller may control either the first high voltage battery or the second high voltage battery to operate to supply power to the first driving motor while performing conditioning for the other one.

### CROSS REFERENCE TO RELATED APPLICATIONS

The present application claims priority to Korean Patent Application No. 10-2023-0146894, filed on Oct. 30, 2023, the entire contents of which is incorporated herein for all purposes by this reference.

### TECHNICAL FIELD

The present disclosure relates to a mobility apparatus and a method of conditioning the battery thereof.

### BACKGROUND

The statements in this section merely provide background information related to the present disclosure and may not constitute prior art.

Generally, electric vehicles, a type of mobility apparatus, are driven with their wheels driven by a driving force of a driving motor.

In addition, it is common for a high voltage battery to be fixed to and mounted on the vehicle to supply power to the driving motor.

The driving motor may be an AC motor, so an inverter may be arranged between the battery and the driving motor.

When the battery of an electric vehicle requires charging according to its state of charge (SOC), it is charged by receiving external power through an on-board charger (OBC).

The time required for charging an electric vehicle is determined depending on the charging method, and there are two main types of charging: slow charging and fast charging.

By virtue of continuous research and development on batteries, in recent days, driving range per charge has been significantly improved.

However, the battery fixed to and mounted on the battery of an electric vehicle may still be insufficient, so an alternative is needed.

The information included in this Background of the present disclosure section is only for enhancement of understanding of the general background of the present disclosure and may not be taken as an acknowledgement or any form of suggestion that this information forms the prior art already known to a person skilled in the art.

### SUMMARY

The present disclosure is aimed at resolving the above-described problems.

The present disclosure is aimed at proposing a new concept of using a second high voltage battery that can be attached to and detached from the power system of an electric vehicle as needed in addition to a first high voltage battery that has been already installed in the electric vehicle.

In addition, one embodiment of the present disclosure is aimed at optimizing driving efficiency by pre-conditioning batteries to allow them to be optimized for driving conditions and a driver's driving habits, i.e., driving power.

The mobility apparatus according to an embodiment of the present disclosure may include a plurality of first wheels, at least one first driving motor configured to provide a driving force to the plurality of first wheels, a first high voltage battery configured to supply power to the at least one first driving motor, and a first controller configured to control the at least one first driving motor and the first high voltage battery, and, when a second battery is removably and electrically connected to the mobility apparatus, the first controller performs a driving control of controlling one of the first battery and the second battery to supply power to the first driving motor while performing a conditioning control for the other one.

According to at least one embodiment of the present disclosure, the first controller may also determine the target power for each section of a driving route.

According to at least one embodiment of the present disclosure, the first controller determines the target power based on learning data.

According to at least one embodiment of the present disclosure, the first controller also determines a first target temperature for the first battery and a second target temperature for the second battery based on the target power.

According to at least one embodiment of the present disclosure, the first controller determines the first target temperature and the second target temperature based on specifications and/or states of the first battery and the second battery, respectively.

According to at least one embodiment of the present disclosure, for each section of the driving route, the first controller determines one among the first battery and the second battery for the driving control and the other one for the conditioning control.

According to at least one embodiment of the present disclosure, the first controller determines the one for the driving control and the other one for the conditioning control for each section of the driving route based on energy efficiency.

According to at least one embodiment of the present disclosure, the first controller determines a conditioning strategy based on conditioning power for the other one determined for the conditioning control.

According to at least one embodiment of the present disclosure, the first controller determines the conditioning power based on an expected conditioning energy.

According to at least one embodiment of the present disclosure, the conditioning strategy includes determining at least one of a conditioning method or a time point when the conditioning control begins.

According to at least one embodiment of the present disclosure the conditioning method includes external conditioning based on an external cooling and/or heating means and self-conditioning based on self-heating by charging or discharging.

According to an embodiment of the present disclosure, a method of conditioning a battery of a mobility apparatus may be provided, and the mobility apparatus may include a plurality of first wheels, at least one first driving motor configured to provide a driving force to the plurality of first wheels, a first battery configured to supply power to the at least one first driving motor, and a first controller configured to control the at least one first driving motor and the first battery. In addition, when a second battery is removably and electrically connected to the first mobility apparatus, the first controller performs a driving control of controlling one of the first battery and the second battery to supply power to the first driving motor while performing a conditioning control for the other one.

According to at least one embodiment of the present disclosure, the first controller may also determine a target power for each section of a driving route.

According to at least one embodiment of the present disclosure, the first controller determines the target power based on learning data.

According to at least one embodiment of the present disclosure, the first controller also determines a first target temperature for the first battery and a second target temperature for the second battery based on the target power.

According to at least one embodiment of the present disclosure, the first controller determines the first target temperature and the second target temperature based on specifications and/or states of the first battery and the second battery, respectively.

According to at least one embodiment of the present disclosure, for each section of the driving route, the first controller determines one among the first battery and the second battery for the driving control and the other one for the conditioning control.

According to at least one embodiment of the present disclosure, the first controller determines the one for the driving control and the other one for the conditioning control for each section of the driving route based on energy efficiency.

According to at least one embodiment of the present disclosure, the first controller determines a conditioning strategy based on conditioning power for the other one determined for the conditioning control.

According to an embodiment of the present disclosure, an add-on mobility apparatus removably connected to another mobility apparatus may be provided, wherein the another mobility apparatus may include a plurality of first wheels, at least one first driving motor configured to provide a driving force to the plurality of first wheels, a first battery configured to supply power to the at least one first driving motor, and a first controller configured to control the at least one first driving motor and the first battery, and the add-on mobility apparatus may include a second battery detachably and electrically connected to the first mobility apparatus and a second controller. In addition, when the second battery is electrically connected to the first mobility apparatus, the second controller performs a driving control of controlling one of the first battery and the second battery to supply power to the first driving motor while performing a conditioning control for the other one.

According to an embodiment of the present disclosure, it may be possible to extend the driving range of an electric vehicle and improve its usability by removably connecting the second high voltage battery to the electric vehicle's power system.

In addition, according to an embodiment of the present disclosure, it may be possible to optimize driving efficiency by pre-conditioning batteries to allow them to be optimized for driving conditions and a driver's driving habits, i.e., driving power.

For example, before a vehicle enters section B, while the vehicle is driving in section A, the first high voltage battery may be used for the driving power for the driving conditions of section A, and the second high voltage battery may be pre-conditioned to be used for the driving power for the driving conditions of section B, following section A, thereby improving energy efficiency.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE FIGURES

FIG. 1 shows the power system of a first mobility apparatus according to an embodiment of the present disclosure.

FIG. 2 shows how a second mobility apparatus is connected to the first mobility apparatus according to an embodiment of the present disclosure.

FIG. 3 shows the process of controlling a battery according to an embodiment of the present disclosure.

FIG. 4 shows the process of obtaining learning data for each section by being linked to a navigation system while driving in relation to the target power.

FIG. 5 shows the SOH-SOC-temperature map data for each specification of each of the first high voltage battery and the second high voltage battery.

FIG. 6 shows how to determine a battery controlled to operate for each section.

FIGS. 7A and 7B show how conditioning is performed in each section of a driving route according to an embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawing.

### DETAILED DESCRIPTION

Because various changes can be made to the present disclosure and a range of embodiments can be made for the present disclosure, specific embodiments will be illustrated and described in the drawings. However, this is not intended to limit the present disclosure to the specific embodiments, and it should be understood that the present disclosure includes all changes, equivalents, and substitutes within the technology and the scope of the present disclosure.

The terms “module” and “unit” used in the present disclosure are merely used to distinguish the names of components, and should not be interpreted as assuming that the components have been physically or chemically separated or can be so separated.

Terms containing ordinal numbers such as “first” and “second” may be used to describe various components, but the components are not limited by the terms. The above-mentioned terms can be used only as names to distinguish one component from another component, and the order therebetween can be determined by the context in the descriptions thereof, not by such names.

The expression “and/or” is used to include all possible combinations of multiple items being addressed. For example, by “A and/or B,” all three possible combinations are meant: “A,” “B,” and “A and B.”

When a component is said to be “coupled” or “connected” to another component, it means that the component may be directly coupled or connected to the other component or there may be other components therebetween.

The terms used herein are only used to describe specific embodiments and are not intended to limit the present disclosure. Expressions in the singular form include the meaning of the plural form unless they clearly mean otherwise in the context. In the present disclosure, expressions such as “comprise” or “have” are intended to indicate the presence of features, numbers, steps, operations, components, parts, or combinations thereof described herein, and should not be understood as precluding the possibility of the presence or the addition of one or more other features, numbers, steps, operations, components, parts, or combinations thereof.

Unless otherwise defined, all terms used herein, including technical or scientific terms, have meanings commonly understood by a person having ordinary skill in the technical field to which the present disclosure pertains. Terms defined in commonly used dictionaries should be interpreted as having meanings consistent with the meanings they have in the context of the relevant technology, and should not be interpreted in an ideal or overly formal sense unless explicitly defined in the present disclosure.

In addition, a unit, a control unit, a control device, or a controller is only a term widely used to name devices for controlling a certain function, and do not mean a generic function unit. For example, devices with these names may include a communication device that communicates with other controllers or sensors to control a certain function, a computer-readable recording medium that stores an operating system, logic instructions, input/output information, etc., and one or more processors that perform operations of determination, calculation, making decisions, etc. required to control the function.

Meanwhile, the processor may include a semiconductor integrated circuit and/or electronic devices that carry out operations of at least one of comparison, determination, calculation, and making decisions to perform a programmed function. For example, the processor may be any one or a combination of a computer, a microprocessor, a CPU, an ASIC, and an electronic circuit such as circuitry and logic circuits.

Examples of a computer-readable recording medium (or simply called a memory) may include all types of storage devices for storing data that can be read by a computer system. For example, they may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, and an optical disk.

Such a recording medium may be electrically connected to the processor, and the processor may load and write data from the recording medium. The recording medium and the processor may be integrated or may be physically separate.

Hereinafter, the attached drawings will be briefly described, and, with reference to the drawings, the embodiments of the present disclosure will be described in detail.

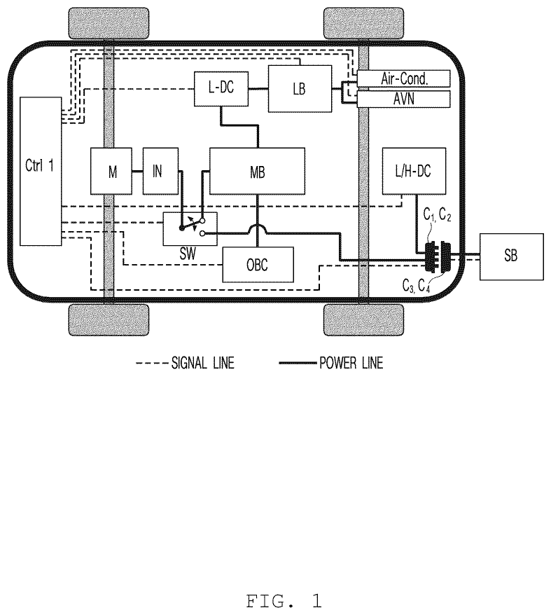

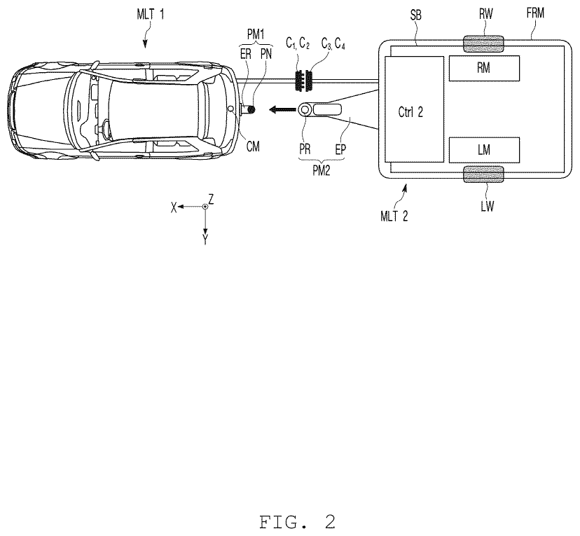

FIG. 1 conceptually shows the power system of a first mobility apparatus MLT 1 (e.g., an electric vehicle) according to an embodiment of the present disclosure, and FIG. 2 shows how a second mobility apparatus MLT 2 is connected to the first mobility apparatus MLT 1. The second mobility apparatus MLT 2 may be refer to as an add-on mobility apparatus.

With reference to FIGS. 1 and 2, the structure of each of the first mobility apparatus MLT 1 and the second mobility apparatus MLT 2 according to an embodiment of the present disclosure will be described.

As shown in FIG. 1, the first mobility apparatus MLT 1 according to an embodiment of the present disclosure is, for example, an electric vehicle, and may include a first driving motor M, an inverter IN, a first high voltage battery MB, an on-board charger OBC, a first DC/DC converter L-DC, a low voltage battery LB, an air-conditioning device Air-cond. and an audio video navigation AVN, which operate at low voltage, a second DC/DC converter L/H-DC, a switch SW, and a controller (hereinafter, referred to as a “first controller”).

The first driving motor M may provide a driving force to the wheels of a vehicle and may be an AC motor for example.

The inverter IN may convert a direct current power supplied to the first driving motor M into alternating current.

The first high voltage battery MB may be fixed to and installed in the body of the first mobility apparatus MLT 1, for example, under the floor of the passenger compartment.

The main function of the first high voltage battery MB may be to supply electric power to the first driving motor M and can be charged with the on-board charger OBC.

In addition, the first high voltage battery MB may be connected to the low voltage battery LB through the first DC/DC converter L-DC to charge the low voltage battery LB.

For charging the low voltage battery LB, the first DC/DC converter L-DC may be a low-voltage DC-DC converter LDC.

The low voltage battery LB may be, for example, a 12 V or 24 V battery, and may supply electric power to electrical devices in a vehicle, such as an air-conditioning device and an AVN, which operate at low voltage.

A second high voltage battery SB shown in FIG. 1 may be installed in the second mobility apparatus MLT 2, but is not necessarily limited thereto. For example, the second high voltage battery SB may be removably installed in the first mobility apparatus.

The second high voltage battery SB may be additionally connected to a vehicle's power system including the first high voltage battery MB. That is, the second high voltage battery SB may be detachably and electrically connected to the power system by wire (or wirelessly within possible range) in a manner that the absence of the second high voltage battery SB has no effect on the operation of the power system (power supply to electronics, a driving motor, etc. of a vehicle).

In addition, the second high voltage battery SB may be referred to as a replaceable battery, an auxiliary battery, an extended battery, or a secondary battery, but this is only to distinguish the second high voltage battery SB from the first high voltage battery MB. In other words, anything regarding the second high voltage battery SB, such as the functions, the features, its own mechanical/electrical/chemical structure or that in relationship with other objects (including the first high voltage battery MB, a host vehicle, etc.), the type of battery (including a packaging method and the type of anode material, cathode material, separator, etc.), and the charging method, is not limited by how it is called.

It may be possible for the second high voltage battery SB to communicate with a first controller Ctrl 1 of the first mobility apparatus MLT 1 or a battery management system (BMS) of the first high voltage battery MB, which will be described below, by wire or wirelessly, so that various sensing information (e.g., voltage, current, temperature, etc.) related to the state of charge (SoC) and the physical/electrical/chemical state of the second high voltage battery SB may be transmitted to the first controller Ctrl 1. However, not necessarily limited thereto, the above-mentioned information related to the second high voltage battery SB may also be transmitted to the first controller Ctrl 1 through a second controller Ctrl 2 of the second mobility apparatus MLT 2, which will be described below.

According to this embodiment of the present disclosure, the high voltage battery applied to the first high voltage battery MB and the second high voltage battery SB may include, for example, a plurality of battery cells (not shown) outputting a voltage of 2.7 to 4.2 V, and a set number of battery cells may be connected in series/parallel to each other to form one module. The high voltage battery may be in the form of one or more battery modules connected to each other in series/parallel and thus packaged in one battery package to output a desired voltage, e.g., a voltage of about 400 V, about 800 V, or several kV.

The first high voltage battery MB and the second high voltage battery SB may each include the BMS.

The BMS may include a battery management unit (BMU), a cell monitoring unit (CMU), and a battery junction box (BJB).

The BMS may perform a cell balancing function to ensure the performance of the entire battery pack by maintaining the voltage of each cell constant, a SoC function to calculate the capacity of the entire battery system, control of battery cooling, charging, and discharge, etc.

The BMU may receive information on each cell from the CMU and fulfill the functions of the BMS based thereon.

For example, the BMU may include two micro control units (MCUs), and each MCU may have one CAN communication port. A CAN interface may be included for the communication with a vehicle controller, which can be said to be the upper device of the BMS, and a CAN interface may be included to collect information from the CMU, which is the lower device thereof.

The CMU may be directly attached to a battery cell and monitor voltage, current, temperature, etc. The CMU may not perform calculations related to the BMS algorithm and may only serve to monitor. One CMU may be connected to multiple battery cells, and may transmit information on each cell to the BMU through a CAN interface.

The BJB may be the mechanism for determining the pack-level of the BMS and the medium that connects the high voltage battery and drivetrain. The BJB may measure and record a battery's voltage and the current flowing in and out of the battery to accurately calculate the SoC. In addition, the BJB may perform important functions for safety, such as monitoring of insulation as well as detecting of overcurrent.

The second high voltage battery SB may be a high-voltage battery with a lower voltage than the first high voltage battery MB, and, in this case, the second DC/DC converter L/H-DC may be a DC/DC converter for voltage boosting. In contrast, the second high voltage battery SB may be a high-voltage battery with a higher voltage than the first high voltage battery MB, and, in this case, the second DC/DC converter L/H-DC may be a DC/DC converter for step-down.

According to this embodiment of the present disclosure, the second DC/DC converter L/H-DC may be built into the first mobility apparatus MLT 1 in the power system, but is not limited thereto. For example, unlike this embodiment, the second DC/DC converter L/H-DC may be provided as a separate component and may be additionally and detachably connected to the power system. In addition, the second DC/DC converter L/H-DC may be built into or detachably included in the second mobility apparatus MLT 2.

According to this embodiment of the present disclosure, for the detachable and electrical connection to the power system of the second high voltage battery SB, the power system of the first mobility apparatus MLT 1 may include first and second connectors C1 and C2, and the second high voltage battery SB may include third and fourth connectors C3 and C4.

For example, the first and second connectors C1 and C2 may be in the form of one integrated connector, and the third and fourth connectors C3 and C4 may also be in the form of one integrated connector.

The first connector C1 may be connected to the second DC/DC converter L/H-DC, and the second connector C2 may be connected to the switch SW.

Meanwhile, although not shown, it is needless to say that a connector for transmitting signals may be added to transmit various sensing and state information on the second high voltage battery SB to the controller.

The switch SW may be fixed to and electrically connected to the inverter IN, and may be turned on between the first high voltage battery MB and the second connector C2 to electrically connect the inverter IN and the first high voltage battery MB or the inverter IN and the second high voltage battery SB.

In addition, according to this embodiment of the present disclosure, the first controller Ctrl 1 may be the highest-level vehicle controller that controls all electric devices of the first mobility apparatus MLT 1, but is not necessarily limited thereto. That is, for example, the first controller Ctrl 1 in FIG. 1 may be a power controller subordinate to a vehicle controller.

Furthermore, as described above, the first controller Ctrl 1 according to this embodiment may include computer-readable recording media that store operating systems, logic instructions, input/output information, etc. and one or more processors that read them and perform the operation of making determinations and decisions, doing calculations, etc. to control the functions.

The second high voltage battery SB in FIG. 1 may be installed in the second mobility apparatus MLT 2 as shown in FIG. 2.

The second mobility apparatus MLT 2 may include a frame FRM, a second left wheel LW installed on the left side of the frame FRM, a second right wheel RW installed on the right side of the frame FRM, a second left driving motor LM for providing a driving force to the second left wheel LW, a second right driving motor RM for providing a driving force to the second right wheel RW, and the second controller Ctrl 2.

The second high voltage battery SB may be fixed to and installed in the second mobility apparatus MLT 2, but is not necessarily limited thereto. That is, the second high voltage battery SB may be removably installed in the second mobility apparatus MLT 2. As a result, it may be possible to replace the second high voltage battery SB mounted on the frame FRM with the SoC of being fully discharged with a new second high voltage battery SB with the SoC of being fully charged.

When the second high voltage battery SB is fixed to and installed in the second mobility apparatus MLT 2, the second mobility apparatus MLT 2 may include a charging connector for charging the second high voltage battery SB.

The frame FRM may form the exterior of the second mobility apparatus MLT 2 and may serve to accommodate other components.

The frame FRM may include a second pivot mechanism PM2 as a second connection mechanism, and the second pivot mechanism PM2 may be detachably and pivotably connected to a first pivot mechanism PM1, which is a first connection mechanism fixed to the body of the first mobility apparatus MLT 1.

For example, the first pivot mechanism PM1 may include an extension rod ER extending rearwardly from the body of the first mobility apparatus MLT 1 and a pivot pin PN protruding upward from an end of the extension rod ER.

In addition, the second pivot mechanism PM2 may include a triangular-shaped extension portion EP protruding forward from the frame FRM of the second mobility apparatus MLT 2 and a pivot ring PR into which the pivot pin PN may be rotatably inserted at the end of the extension portion EP.

When the pivot pin PN is inserted into the pivot ring PR, the linear movement of the pivot pin PN may be limited, and it may only rotate in the Z-axis direction in FIG. 2. Therefore, when the second mobility apparatus MLT 2 is pivotably connected, the linear movement of the second mobility apparatus MLT 2 may be limited about the pivot connection point with respect to the first mobility apparatus MLT 1, and the second mobility apparatus MLT 2 may only rotate about the Z axis.

When driving in the forward direction, that is, in the X-axis direction, the first mobility apparatus MLT 1 and the second mobility apparatus MLT 2 may remain in a straight line even without separate control of the steering of the second mobility apparatus MLT 2.

According to this embodiment, the pivot mechanisms as the first and second connection mechanisms may be included, but it is not necessarily limited thereto. For example, the first and second connection mechanisms may be well-known mechanisms that enable non-rotational connection about the Z axis.

The rotation axis of the second left driving motor LM may be connected to the second left wheel LW so that the second left driving motor LM may supply a driving force to the second left wheel LW.

In addition, the rotation axis of the second right driving motor RM may be connected to the second right wheel RW so that the second right driving motor RM may supply a driving force to the second right wheel RW.

Because the second left wheel LW and the second right wheel RW may respectively be connected to the second left driving motor LM and the second right driving motor RM, it may be possible to drive them independently of each other.

It may be possible to drive the second left driving motor LM and the second right driving motor RM in the forward and reverse directions. When they are driven in the forward direction, the second mobility apparatus MLT 2 may travel forward, and, when they are driven in the reverse direction, it may travel backwards.

For example, the second left driving motor LM and the second right driving motor RM may each be designed as an in-wheel driving system where a driving motor is installed within a wheel, but they are not necessarily limited thereto.

In addition, unlike this embodiment, the second mobility apparatus MLT 2 may be driven in the matter that the left and right sides of the second mobility apparatus MLT 2 are not independent of each other and the power of one common motor is divided and transmitted to the second left wheel LW and the second right wheel RW. To this end, a differential gear may be disposed between a common second driving motor and the second left wheel LW and the second right wheel RW. That is, the power of the common second driving motor may be distributed to the second left wheel LW and the second right wheel RW by the differential gear. In this case, a torque vectoring means may be added to distribute torque among the second left wheel LW and the second right wheel RW.

Referring to FIG. 2, the second controller Ctrl 2 may control the second left driving motor LM and the second right driving motor RM to allow the second mobility apparatus MLT 2 to travel forward and backward. In addition, when the steering of the second mobility apparatus MLT 2 is required, the second controller Ctrl 2 may control the torque or the number of rotations of each of the second left driving motor LM and the second right driving motor RM to change the direction in which the second mobility apparatus MLT 2 travels. That is, the driving of the second left driving motor LM and the second right driving motor RM may be separately controlled, so that it may be possible to achieve the steering of the second mobility apparatus MLT 2 without a separate steering device.

In addition, as described above, a wired or wireless communication means for transmitting information between the connectors in FIG. 1 and the first and second mobilities MLT 1 and MLT 2 may be included.

Meanwhile, according to this embodiment, the first controller Ctrl 1 or the second controller Ctrl 2 may include a memory and a processor. Computer instructions for performing the functions of a corresponding controller may be stored in the memory, and the processor may perform the above-mentioned functions by loading the instructions from the memory and executing them.

For example, the memory may include at least one of a hard disk drive (HDD), a solid-state drive (SSD), a silicon disk drive (SDD), a ROM, a RAM, a CD-ROM, a magnetic tape, a floppy disk, and an optical data storage device.

In addition, for example, the processor may include at least one of a computer, a microprocessor, a central processing unit (CPU), an ASIC, an electric circuit, and a logic circuit.

The first and second connectors C1 and C2 of the first mobility apparatus MLT 1 and the third and fourth connectors C3 and C4 of the second mobility apparatus MLT 2 may be connected to each other, and the connector for transmitting signals may be connected, so that it may be possible that the first mobility apparatus MLT 1 and the second mobility apparatus MLT 2, that is, the first controller Ctrl 1 and the second controller Ctrl 2, communicate with each other.

When the first mobility apparatus MLT 1 starts to drive forward with the first mobility apparatus MLT 1 and the second mobility apparatus MLT 2 mechanically and electrically connected to each other, according to the signal transmitted from the first connector C1 for the driving speed, the second controller Ctrl 2 may control the second left driving motor LM and the second right driving motor RM to enable the second mobility apparatus MLT 2 to drive straight ahead.

In that case, some or all of the speed, the position of the gear, the steering angle, the information on an accelerator pedal sensor (APS), and the information on a brake pedal sensor (BPS) of the first mobility apparatus MLT 1 may be transmitted to the second mobility apparatus MLT 2.

For example, the second controller Ctrl 2 of the second mobility apparatus MLT 2 may determine whether the first mobility apparatus MLT 1 is traveling forward or backward, based on some or all of the speed, the position of the gear, the information on an accelerator pedal sensor (APS), and the information on a brake pedal sensor (BPS) of the first mobility apparatus MLT 1. However, the present disclosure is not limited thereto, and it goes without saying that the second controller Ctrl 2 of the second mobility apparatus MLT 2 may receive the information on whether the first mobility apparatus MLT 1 is traveling forward or backward directly from the first controller Ctrl 1.

When the first mobility apparatus MLT 1 is traveling forward, the second controller Ctrl 2 may drive the second left driving motor LM and the second right driving motor RM in the forward direction to allow the second mobility apparatus MLT2 to drive straight ahead. Furthermore, when the first mobility apparatus MLT 1 is traveling backward, the second controller Ctrl 2 may drive the second left driving motor LM and the second right driving motor RM in the reverse direction to allow the second mobility apparatus MLT2 to drive backward.

In addition, the second controller Ctrl 2 may determine how the first mobility apparatus MLT 1 is being steered based on information on the steering angle of the first mobility apparatus MLT 1, and may steer the second mobility apparatus MLT 2 accordingly.

The second mobility apparatus MLT 2 may not include a separate steering device such as a steering wheel and a steering rack, and it may be possible to steer the second mobility apparatus MLT 2 by controlling the torque of the second left driving motor LM and the second right driving motor RM.

That is, the second controller Ctrl 2 may calculate a driving torque for driving and a steering torque for steering for each of the second left driving motor LM and the second right driving motor RM to perform the control operation.

For example, for the steering of the second mobility apparatus MLT 2, the steering torque values of the second left driving motor LM and the second right driving motor RM according to the steering angle of the first mobility apparatus MLT 1 may be included in a lookup table or a calculation program.

When the second mobility apparatus MLT 2 drives straight ahead, the speed of the second mobility apparatus MLT 2 may be controlled to be no greater than that of the first mobility apparatus MLT 1. As a result, the pivot connection between the first mobility apparatus MLT 1 and the second mobility apparatus MLT 2 may be maintained at a pivot angle within a predetermined range. For example, when the speed of the second mobility apparatus MLT 2 driving straight ahead is controlled to be no greater than that of the first mobility apparatus MLT 1, at the pivot connection point, the pivot angle between the second mobility apparatus MLT 2 and the first mobility apparatus MLT 1 may be maintained at 0 degree, i.e., the angle where the first mobility apparatus MLT 1 and the second mobility apparatus MLT 2 are in a straight line.

When the second mobility apparatus MLT 2 is driving forward, it may be controlled to follow the first mobility apparatus MLT 1, so that the driving of multiple mobilities connected to each other may be smoothly performed.

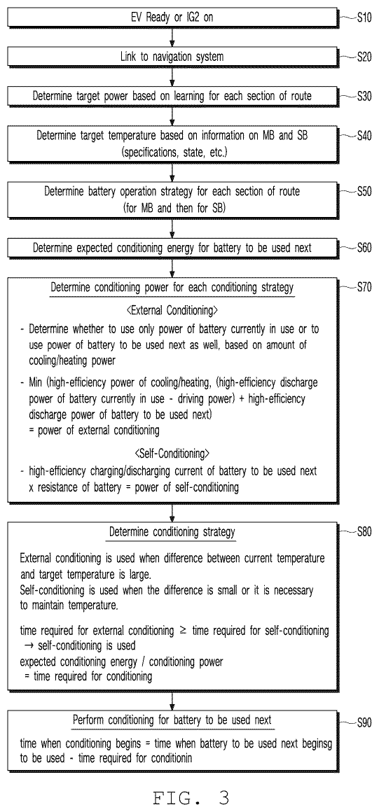

FIG. 3 shows the process of controlling the first and second batteries according to an embodiment of the present disclosure, which will be described in detail below. In the embodiment, one of the first and second batteries may controlled under a conditioning control while the other one is under a driving control to supply power to the first driving motor M.

The process in FIG. 3 may be performed by the first controller Ctrl 1 or the second controller Ctrl 2, but, in this embodiment, for convenience of description, the process performed by the first controller Ctrl 1 will be described.

First, at S10, the driving control mode of the first mobility apparatus MLT 1, that is, the power mode according to the driving state thereof, may be the “IG2 on” mode or the “EV Ready” mode.

Examples of the driving control mode may include the IG1, IG2, and EV Ready modes.

In the state of IG1 on, the corresponding switches of the related relays may have been turned on so that power can be supplied to designated electronic devices not related to driving, including convenience devices in a vehicle, such as an air conditioning system and an AVN.

In the state of IG2 on, the corresponding switches of the related relays may have been turned on so that power can be supplied to all electronic devices in a vehicle, including various controllers.

In addition to the state of IG2 on, the state of EV Ready may be a state in which a vehicle control unit may have turned capable of starting driving at any time according to signals sensed by an accelerator pedal sensor (APS) and/or a brake pedal sensor (BPS). When the EV Ready mode has started, control functions necessary for driving may be activated.

At S20, the first controller Ctrl 1 may be linked to a navigation system to obtain data on a driving route and driving in each section of the route.

For example, the route on a navigation system may be determined based on the destination selected by a driver, and the route may be divided into a plurality of sections based on the type of road or learning data, which will be described below.

The first controller Ctrl 1 may determine the target power for each section at S30.

According to this embodiment of the present disclosure, the target power may be determined based on the learning data, which will be described below, but is not necessarily limited thereto. For example, the energy for driving a vehicle in each section may be determined based on the type of road in each section, the slope, etc., and the target power for each section may also be determined based on the energy.

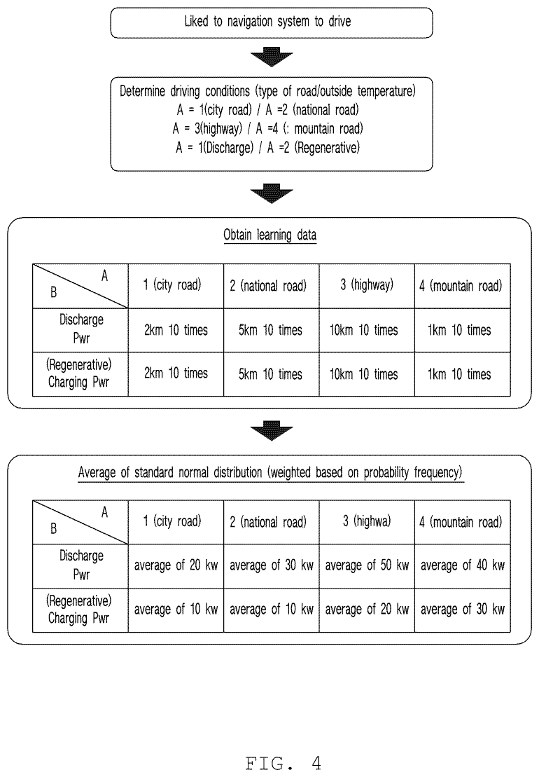

According to this embodiment, the target power may be based on the learning data, which will be described with reference to FIG. 4.

First, while the first mobility apparatus MLT 1 is driving, it may be linked to a navigation system to obtain power data based on a driver's driving habits under specific conditions, such as the type of road and outside temperature.

For example, while a driver is driving on a city road, a national road, a highway, a mountain road, etc., data on outside temperature and driving power may be obtained and accumulated. For example, as shown in FIG. 4, on a city road, data on driving for a distance of 2 km may be obtained 10 times; on a national road, data on driving for a distance of 5 km may be obtained 10 times; on a highway, data on driving for a distance of 10 km may be obtained 10 times; and, on a mountain road, data on driving for a distance of 1 km may be obtained 10 times. In addition, data on discharge power and charging power by regenerative braking may be obtained for each road.

As shown in FIG. 4, the average of the data obtained in that way may be determined based on the standard normal distribution for each road. Here, the average may be determined by applying weights according to probability frequency.

Referring to FIG. 4, for example, the average power of the city road may be 20 kw for discharge and 10 kw for regenerative charging, the average power of the national road may be 30 kw for discharge and 10 kw for regenerative charging, the average power of the highway may be 50 kw for discharge and 20 kw for regenerative charging, and the average power of the mountain road may be 40 kw for discharge and 30 kw for regenerative charging.

According to this embodiment, the learning data for determining target power may be classified according to the type of road, but is not necessarily limited thereto.

For example, a frequently used route may be divided into sections based on criteria other than the type of road, and the learning data may also be secured in the above-described manner by obtaining driving power as data on a driver's driving in each section.

In addition, a route may be divided into sections based only on a driver's driving habits, not on map information, including information on road characteristics such as the type of road, the slope, and the number of lanes, on a navigation system. For example, while a driver is driving on route A, data on the driver's driving power may be obtained, and sections of route A may be divided based on the driving power. For example, for route A, based on the data on the driving power, section a with an average power of P1, section b with an average power of P2, and section c with an average power of P3 may be determined, and route A may be divided into the three sections.

Referring back to FIG. 3, after determining the target power for each section, at S40, the first controller Ctrl 1 may determine a first target temperature of the first high voltage battery MB and a second target temperature of the second high voltage battery SB for each section.

The target temperature may be determined based on the specifications, including a C-rate, a nominal voltage, efficiency, etc., and/or the state, such as SOH, SOC, and temperature, of a battery.

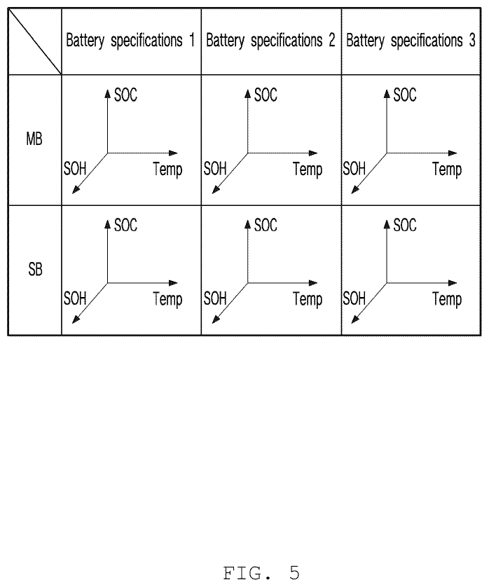

FIG. 5 illustrates the SOH-SOC-temperature map data for each specification of each of the first high voltage battery MB and the second high voltage battery SB, and, according to this embodiment, the first target temperature and the second target temperature may be determined based on such map data.

Each of the map data in FIG. 5 may include at least one empirical formula or theoretical formula or a lookup table, and may be stored in a memory.

Next, the first controller Ctrl 1 may determine a battery operation strategy for each section at S50.

Developing of the operation strategy may include determining which battery will be controlled to operate and which battery will be controlled to be conditioned for each section. Here, the battery controlled to operate may be controlled to supply power to the first driving motor M, and the battery controlled to be conditioned may be controlled to have an optimal temperature through cooling or heating.

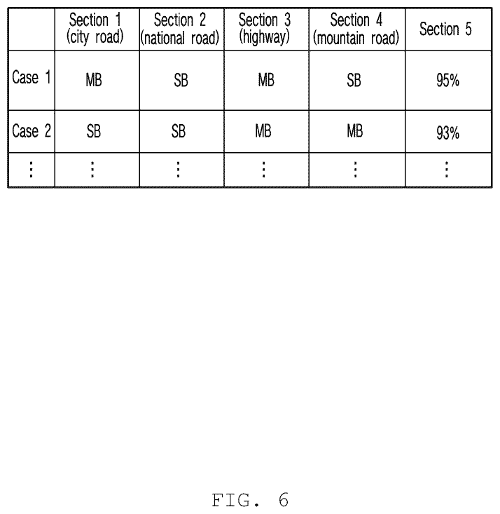

As shown in FIG. 6, in order to determine the operation strategy, the first controller Ctrl 1 may assume multiple cases where a battery controlled to operate varies in each section and determine the energy efficiency in each case.

For example, referring to FIG. 6, in case 1, the first high voltage battery MB is controlled to operate in sections 1 and 3, and the second high voltage battery SB is controlled to operate in sections 2 and 4. In addition, in case 2, the second high voltage battery SB is controlled to operate in sections 1 and 2, and the first high voltage battery MB is controlled to operate in sections 3 and 4. FIG. 6 shows only cases 1 and 2, but the number of cases may be greater than two.

Referring to FIG. 6, the first controller Ctrl 1 may calculate the energy efficiency in each of cases 1 and 2, and may select case 1 with a higher efficiency.

For example, the energy efficiency for each section may be determined through calculation using, as an input, the energy required to exert an output power determined based on the corresponding target power during the section. For example, the energy required to produce a target power with the first high voltage battery MB in section 1 in case 1 may be determined based on an output power multiplied by the duration of time required to drive in the corresponding section, wherein the output power may be determined based on the state (SOH, SOC, temperature) of the first high voltage battery MB.

When the battery operation strategy has been determined at S50, the first controller Ctrl 1 may determine the expected conditioning energy for a battery to be used next time at S60.

For example, when case 1 in FIG. 6 has been selected, the battery that the vehicle currently driving in section 1 will use next time is the second high voltage battery SB. In this case, at S60, the first controller Ctrl 1 may calculate the expected conditioning energy for the second high voltage battery SB to be used for driving in section 2.

For example, the expected conditioning energy may be determined by adding the energy for a change in battery temperature and the energy for a change in coolant temperature.

Here, the energy for a change in battery temperature may be determined by multiplying the mass of a battery by the specific heat of the battery and the difference between the current temperature and the target temperature. In addition, the energy for a change in coolant temperature may be determined by multiplying the mass of coolant by the specific heat of the coolant and the difference between the current water temperature and the target water temperature.

It goes without saying that, when heating is necessary, heat energy from a heater may be used instead of the energy for a change in coolant temperature.

Next, the first controller Ctrl 1 may determine a conditioning strategy based on a conditioning power for a battery controlled to be conditioned, which will be described below. Here, developing of the conditioning strategy may include determining at least one of a method of conditioning batteries and the time when the conditioning begins. In addition, examples of the method of conditioning batteries may include external conditioning based on an external cooling and/or heating means and self-conditioning based on self-heating by charging and discharging.

First, the first controller Ctrl 1 may determine the conditioning power for each conditioning strategy at S70.

The first controller Ctrl 1 may determine the conditioning power for the external conditioning and the conditioning power for the self-conditioning at S70.

For example, when the value obtained by subtracting the driving power from the high-efficiency discharge power of a battery currently in use (i.e., a battery currently controlled to operate) is greater than the high-efficiency power of the cooling or heater, conditioning may be performed for a battery to be used next time (i.e., a battery controlled to be conditioned) using only the battery currently in use.

In addition, when the value obtained by subtracting the driving power from the high-efficiency discharge power of the battery currently in use is less than or equal to the high-efficiency power of the cooling or heater, the conditioning may be performed using the battery currently in use and the battery to be used next time.

Here, the high-efficiency discharge power of a battery, which has been mentioned above, may be determined based on the efficiency map data that has been predetermined and stored based on at least one of the SOC, temperature, and SOH of the battery.

The output power for the external conditioning may be the smaller of “the high-efficiency power of cooling or heater” and “the value obtained by adding the high-efficiency discharge power of a battery to be used next to the value obtained by subtracting the driving power from the high-efficiency discharge power of a battery currently controlled to operate.”

In addition, the output power of the self-conditioning may be determined by multiplying the high-efficiency charging/discharging current of a battery to be used next by the resistance of the battery.

When the conditioning power is determined for each method of conditioning batteries at S70, the first controller Ctrl 1 may determine a conditioning strategy at S80.

Here, when the difference between the current temperature of the battery controlled to be conditioned and the target temperature thereof is equal to or greater than a set value, the external conditioning may be selected, and, otherwise, the self-conditioning may be selected.

In addition, when the time required for the external conditioning is equal to or longer than the time required for the self-conditioning, the self-conditioning may be selected as the method of conditioning batteries.

Here, the time required for conditioning may be obtained by dividing the expected conditioning energy by the conditioning power.

Next, the first controller Ctrl 1 may determine the time when the conditioning begins and proceed with the conditioning accordingly at S90.

Here, the time when the conditioning begins may be determined by subtracting the time required for conditioning from the time when a battery controlled to be conditioned becomes a battery controlled to operate, that is, the time when a battery to be used next begins to be used to drive the first driving motor M.

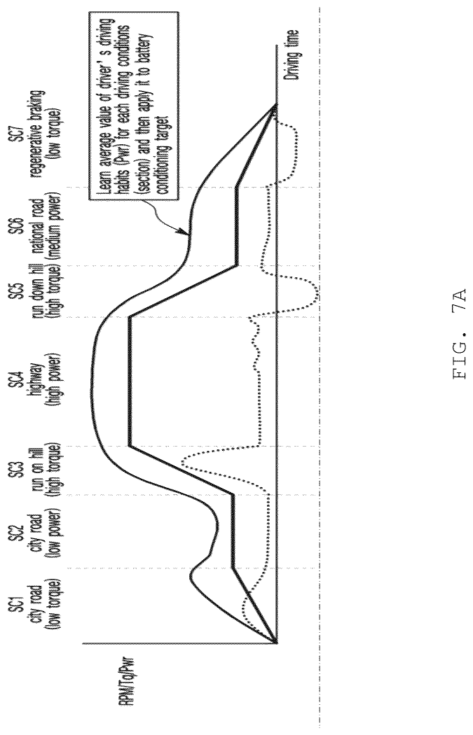

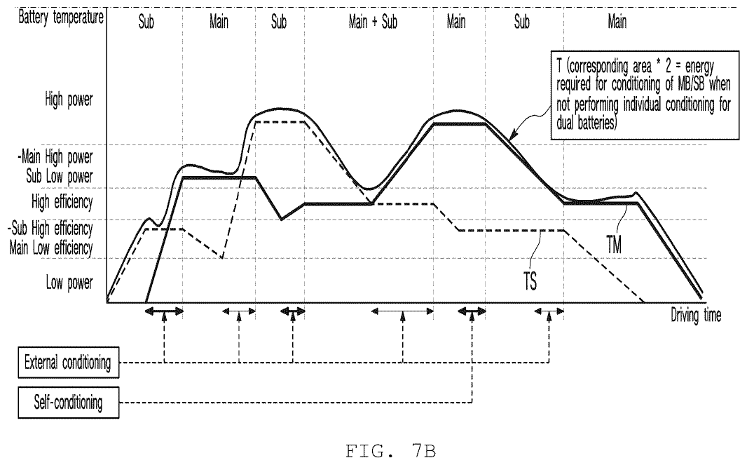

FIGS. 7A and 7B illustrate how conditioning is performed in each section of a driving route according to an embodiment of the present disclosure, which will be described below.

First, FIG. 7A shows the rotation speed RPM, torque Tq, and required power Pwr of the first driving motor M of the first mobility apparatus MLT 1 traveling in each section.

Referring to FIGS. 7A and 7B, in section 1 of the route, a driver has driven at low torque on a city road; in section 2, the driver has driven at low power on a city road; in section 3, the driver has driven at high torque to run on a hill; in section 4, the driver has driven at high power on a highway; in section 5, the driver has driven at high torque to run down a hill; in section 6, the driver has driven at medium power on a national road; and, in section 7, the driver has driven at low torque with regenerative braking.

The above-described learning data may be obtained from driving data such as the graph in FIG. 7A.

The graph in FIG. 7B shows how conditioning is carried out for the first high voltage battery MB or the second high voltage battery SB while a vehicle is driving on the same route as that of the graph at the top.

Referring to FIGS. 7A and 7B, in section 1, the second high voltage battery SB is controlled to operate, and the external conditioning is performed for the first high voltage battery MB before it is used to drive in section 2.

In addition, in section 2, as the first high voltage battery MB is controlled to operate, the external conditioning is performed for the second high voltage battery SB.

In section 3, the second high voltage battery SB is used to drive again, and the external conditioning is performed for the first high voltage battery MB.

In section 4, as both the first high voltage battery MB and the second high voltage battery SB are used to drive, the external conditioning is performed for the first high voltage battery MB.

In section 5, as the first high voltage battery MB is used to drive, the self-conditioning is performed for the second high voltage battery SB. In section 6, as the second high voltage battery SB is used to drive, the external conditioning is performed for the first high voltage battery MB.

In section 7, the first high voltage battery MB is used to drive, and the driving ends when the vehicle arrives at its destination.

Referring to FIG. 7B, according to this embodiment, the energy required for the conditioning of the batteries may correspond to the area of the TM line, which is the temperature line of the first high voltage battery MB, and the area of the TS line, which is the temperature line of the second high voltage battery SB. In addition, when this embodiment is not applied, the energy required for the conditioning of the batteries may be twice the area of the T line, which is a temperature line.

As shown in FIGS. 7A and 7B, much less energy may be required for conditioning of batteries according to this embodiment, compared to when this embodiment is not applied.

According to this embodiment, it is needless to say that cooling means and heating means for each of the first high voltage battery MB and the second high voltage battery SB may be included for cooling and heating.

For example, examples of the cooling means may include at least one of a blower for air cooling, a coolant passage for water cooling, and a coolant pump.

In addition, for example, examples of the heating means may include an electric heater.

The desirable embodiments of the present disclosure have been shown and described, but the present disclosure is not limited to the specific embodiments described above. It is needless to say that various modifications can be made to the present disclosure within the gist of the present disclosure claimed in the appended claims by a person having ordinary skill in the art, and such modifications should not be understood separately from the technology of the present disclosure.

The foregoing descriptions of the specific exemplary embodiments of the present disclosure have been presented for the purposes of illustration and description. They are not intended to be exhaustive or to limit the present disclosure to the precise forms disclosed, and obviously many modifications and variations are possible in light of the above-described teachings. The exemplary embodiments were chosen and described to explain certain principles of the present disclosure and their practical application, to enable others skilled in the art to make and utilize the various exemplary embodiments of the present disclosure, as well as various alternatives and modifications thereof. It is intended that the scope of the present disclosure be defined by the claims appended hereto and their equivalents.

1. A mobility apparatus comprising
a plurality of first wheels;
at least one first driving motor configured to provide driving force to the plurality of first wheels;
a first battery configured to supply power to the at least one first driving motor; and
a first controller configured to control the at least one first driving motor and the first battery;
wherein, when a second battery is removably and electrically connected to the mobility apparatus, the first controller is configured to perform driving control of one of the first battery or the second battery to supply power to the first driving motor and configured to perform conditioning control for an other of the first battery or the second battery.

2. The mobility apparatus of claim 1, wherein the first controller is further configured to determine a target power for each section of a driving route.

3. The mobility apparatus of claim 2, wherein the first controller is configured to determine the target power based on learning data.

4. The mobility apparatus of claim 2, wherein the first controller is further configured to determine a first target temperature for the first battery and a second target temperature for the second battery based on the target power.

5. The mobility apparatus of claim 4, wherein the first controller is configured to determine the first target temperature based on a specification or state of the first battery, and is configured to determine the second target temperature based on a specifications or state of the second battery.

6. The mobility apparatus of claim 5, wherein, for each section of the driving route, the first controller is configured to determine one of the first battery or the second battery for the driving control and the other of the first battery or the second battery for the conditioning control.

7. The mobility apparatus of claim 6, wherein the determining of the first or second battery for the driving control and the first or second battery for the conditioning control for each section of the driving route is based on energy efficiency.

8. The mobility apparatus of claim 6, wherein the first controller is configured to determine a conditioning strategy based on conditioning power for the battery determined for the conditioning control.

9. The mobility apparatus of claim 8, wherein the first controller is configured to determine the conditioning power based on an expected conditioning energy.

10. The mobility apparatus of claim 8, wherein the conditioning strategy includes determining at least one of a conditioning method or a time point when the conditioning control begins.

11. The mobility apparatus of claim 10, wherein the conditioning method includes external conditioning based on an external cooling or heating means and self-conditioning based on self-heating by charging or discharging.

12. A method of conditioning a battery of a mobility apparatus including a plurality of first wheels, at least one first driving motor configured to provide a driving force to the plurality of first wheels, a first battery configured to supply power to the at least one first driving motor, and a first controller configured to control the at least one first driving motor and the first battery,
wherein, when a second battery is removably and electrically connected to the mobility apparatus, the first controller performs a driving control of one of the first battery or the second battery to supply power to the first driving motor, and performs a conditioning control for an other of the first battery or the second battery.

13. The method of claim 12, wherein the first controller further determines a target power for each section of a driving route.

14. The method of claim 13, wherein the first controller determines the target power based on learning data.

15. The method of claim 13, wherein the first controller further determines a first target temperature for the first battery and a second target temperature for the second battery based on the target power.

16. The method of claim 15, wherein the first controller determines the first target temperature based on specification or states of the first battery, and determines the second target temperature based on specifications or states of the second battery.

17. The method of claim 16, wherein, for each section of the driving route, the first controller determines one of the first battery or the second battery for the driving control and the other of the first battery or the second battery for the conditioning control.

18. The method of claim 17, wherein the determination of the first or second battery for the driving control and the first or second battery for the conditioning control for each section of the driving route is based on energy efficiency.

19. The method of claim 17, wherein the first controller determines a conditioning strategy based on conditioning power for the battery determined for the conditioning control.

20. A second mobility apparatus removably connected to a first mobility apparatus including a plurality of first wheels, at least one first driving motor configured to provide driving force to the plurality of first wheels, a first battery configured to supply power to the at least one first driving motor, and a first controller configured to control the at least one first driving motor and the first battery, the add-on mobility apparatus comprising:
a second battery detachably and electrically connected to the first mobility apparatus and a second controller;
wherein, when the second battery is electrically connected to the first mobility apparatus, the second controller is configured to perform driving control of one of the first battery or the second battery to supply power to the first driving motor, and to perform a conditioning control for an other of the first battery or the second battery.
